(19) United States
(12) Patent Application Publication
(10) Pub. No.: US 2026/0236961 A1
(43) Pub. Date: Aug. 13, 2026

(54) ARTIFICIAL INTELLIGENCE-DRIVEN DIGITAL MEDIA CREATIVE PERSONALIZATION AND GENERATION USING NATURAL LANGUAGE MODELS

(71) Applicant: CATALINA MARKETING CORPORATION, St. Petersburg, FL (US)

(72) Inventors: Ronald P. MENICH, Atlanta, GA (US); Zubin SINGH, St. Petersburg, FL (US); Kevin HUNTER, La Jolla, CA (US)

(21) Appl. No.: 19/150,601

(22) PCT Filed: Feb. 9, 2024
(86) PCT No.: PCT/US2024/015282

§ 371 Date: Jul. 24, 2025

Related U.S. Application Data
(60) Provisional application No. 63/444,253, filed on Feb. 9, 2023.

(51) Int. Cl. G06Q 30/0251; G06Q 30/0207

(52) U.S. Cl. CPC G06Q 30/0255; G06Q 30/0224; G06Q 30/0261; G06Q 30/0269

(57) ABSTRACT

An advertising method includes: receiving, from a mobile device with a consumer in a retail store, a location indication, matching a mobile device identifier with a frequent shopper identification for the consumer at the retail store, selecting a list of product items that are likely to be purchased by the consumer based on a purchasing history of the consumer in the retail store associated with the frequent shopper identification, identifying a keyword indicative of a semantic context associated with one or more product items from the list of product items and with a consumer attribute, selecting a media file based on the keyword indicative of the semantic context, and providing an advertisement payload for a one or more product items, including the media file, within a streaming feed for the mobile device with the consumer. A system configured to perform the above method is also provided.

### CROSS-REFERENCE TO RELATED APPLICATIONS

The present disclosure is related and claims priority under 35 U.S.C. 119(e) to U.S. Provisional Patent Application No. 63/444,253 filed on Feb. 9, 2023, the disclosure of which is hereby incorporated by reference in its entirety for all purposes.

### TECHNICAL FIELD

The present disclosure generally relates to advertisements for customers. More specifically, the present disclosure provides systems and methods for determining customer preferences and customizing advertisement payloads to be sent to a customer device.

### BACKGROUND

The present disclosure generally relates to the AI driven digital media creative personalization and generation using natural language models, and the delivery of the advertising payloads to consumers via mobile and desktop computer devices. More generally, the present disclosure relates to personalizing and assembling the creative and delivering the advertisement to consumers and consumer households based on consumer data collected in real time

### DESCRIPTION OF THE RELATED ART

Current techniques for digital media creative personalization and development are manually based, and therefore time-consuming for advertisement agencies. In addition, manual design of advertisement materials may miss elements that are relevant for a consumer, which may actually be decisive components in purchasing decisions.

### DESCRIPTION OF FIGURES

To easily identify the discussion of any particular element or act, the most significant digit or digits in a reference number to the figure number in which that element is first introduced.

FIG. 1 illustrates an example computing environment for providing an advertisement payload.

FIG. 2 illustrates a block diagram illustrating a creative rendering engine.

FIG. 3A illustrates an exemplary first screenshot of an advertisement payload.

FIG. 3B illustrates an exemplary second screenshot of an advertisement payload.

FIG. 3C illustrates an exemplary third screenshot of an advertisement payload.

FIG. 3D illustrates an exemplary fourth screenshot of an advertisement payload.

FIG. 4 illustrates method for providing a personalized advertisement payload to a consumer.

FIG. 5 illustrates an alternative method for providing a personalized advertisement payload to a consumer.

FIG. 6 illustrates a method for training a model to generate a personalized advertisement payload for a consumer.

### DETAILED DESCRIPTION

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure.

### General Overview

The current disclosure is directed to resolve the above problem by incorporating artificial intelligence (AI) and machine learning (ML) tools to create custom, personalized advertisements for consumers, further improving e-commerce experience for consumers. For example, some AI and ML applications may identify “unpredictable” features or attributes of images associated with a product or event to be promoted, which may be difficult, if not impossible, to detect by as human analyst. Some examples of these types of determination may include the use of unsupervised networks that find implicit (e.g., “hidden”) semantic context in one image, or a collection of images. The semantic context can comprise a commonality derived from the collection of images that is relatable or associated with unconscious or conscious actions, personal behaviors, and/or personality traits of the user. The semantic context can vary from person to person, thus customizable with AI and ML tools, when factoring an individual's unconscious or conscious actions when interacting with a product(s), personal behaviors, and/or personality traits.

There is widespread use and availability of machine learning, artificial intelligence, and like tools that can automatically generate desirable multimedia content based on selected keywords, themes, and other semantic concepts associated with a product.

In some embodiments, the digital coupon and promotion technology engine is coupled with a creative rendering server, which uses artificial intelligence algorithms to create and provide to a consumer mobile device a personalized advertisement payload associated with the advertisement technology system. Accordingly, the creative rendering server creates advertisement payloads using ML, AI, and the like, and provides it to the specific consumer through any one of various digital channels such as mobile-web, mobile in-app, desktop, connected TV, and other digital marketing channels.

In some embodiments, a creative rendering engine as disclosed herein may allow a designer to create an extended version of a pre-existing, well-known image, modified sufficiently to convey a desired concept attractive to a specific user, but still recognizable in other generic aspects. An additional advantage of AI/ML enhanced creative rendering engines is the boost provided to the brainstorming process once a new concept is seeded into a team of creators. In addition, the use of AI/ML enhances the creative process because of the speed at which new ideas can be introduced, tried, updated, or modified on the fly, by a team of designers, or a single person.

In some embodiments, AI/ML enhanced advertising may also provide artificially generated, non-descript and photorealistic representations of human models, which also provide a benefit in terms of the time and cost efficiency of not having to look for human models suited for a given campaign or product. In some embodiments, AI/ML models as disclosed herein may even identify physical appearance and features of consumers, based on their expressed reading interests, news consumption, or even comments in social networks. Accordingly, generating artificial human models that conform to these physical attributes in targeted advertisement may highly increase the impact rate of an advertisement campaign.

One example of the above novel concept may include the garment industry, where a targeted advertisement may show an individual having similar physical characteristics of a given consumer, trying different poses and angles of view. The consumer may also choose different colors, sizes, and even stamp or texture designs and materials (either available by the manufacturer or retailer, or custom-made).

In some embodiments, an advertisement technology system as disclosed herein is configured to pull an advertisement payload from the creative rendering server that represents brand manufacturer or retailer content, and command the creative rendering server to push the advertisement payload dynamically to users having a frequent shopper identification (FSC-ID) cards, or generically any semi-persistent advertising identifier, or a series of contextual attributes identifying the media context of the website, mobile or TV application to the user's device—with a network of retailers. The user receives the advertisement payload without having to enter in their retailer centric FSC-ID. When the user clicks on the advertisement payload, including digital coupon and promotion content, the digital coupon and promotion technology engine is triggered to clip the coupon to the associated user's FSC-ID card. Thus, the advertisement technology system may target all users that have FSC-ID cards for multiple retailers associated with a given brand manufacturer. Accordingly, embodiments of the system as disclosed herein increase the impact factor or outreach of a brand manufacturer campaign at a significantly reduced cost.

The subject system provides several advantages including providing an engine that enables to select a large set of target users for a brand campaign. In some embodiments, the campaign is generated by a brand manufacturer that carries one or more CPGs. The campaign may be generated periodically (e.g., once a week) by a brand manufacturer in the interest of attracting customers and/or rewarding loyal customers having a FSC-ID. The retailer may decide to offer certain items for promotion. The system provides an advertisement payload including offers, promotions, and coupons to a user's digital device (desktop, phone, table), based on an FSC-ID associated with the retailer.

Although many examples provided herein describe a user's search inputs or purchasing history being identifiable, or download history for images being stored, each user may grant explicit permission for such user information to be shared or stored. The explicit permission may be granted using privacy controls integrated into the disclosed system. Each user may be provided notice that such user information will be shared with explicit consent, and each user may at any time terminate the information sharing, and may delete any stored user information. The stored user information may be encrypted to protect user security.

In some embodiments, methods as disclosed herein accept online data and user activity for print-at-home offers. Such embodiments may be deployed to support a personalized user experience (e.g., for applying coupons). Further, some embodiments may accept load-to-card offers, where the card may be an FSC-ID.

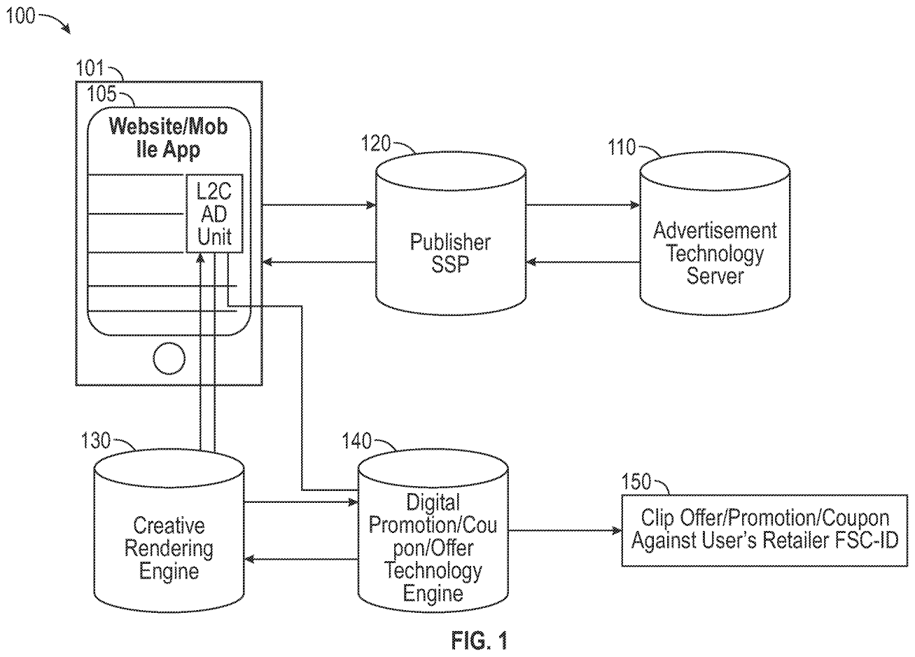

FIG. 1 illustrates a system 100 including a mobile device 101 and at least one network server (e.g., servers 110, 120, 130, and 140), configured to provide an advertisement payload to the user of the mobile device, according to some embodiments. The at least one network server and the mobile device may include a memory and a processor, wherein the memory may include, or may have access to, a database including a lookup table pairing a mobile device identifier (e.g., a mobile cookie ID) with a retail-specific FSC-ID, such as illustrated in TABLE I, below.

TABLE I

| Mobile Cookie ID | Retailer's FSC FSC-ID |
|---|---|
| hsh192zur94 | 384759 |
| su928470184 | 495038 |

System 100 may include an advertisement technology server 110 connected to the digital coupon and promotion technology engine 140, which is a platform configured to receive an advertisement payload from a creative rendering engine 130. For example, in some embodiments, a brand manufacturer may decide to promote a campaign for a certain CPG, or multiple CPGs. Accordingly, the brand manufacturer pushes advertisement keywords or recommendations to the advertisement technology server 110 based on a consumer purchasing history, wherein the consumer is identified by a lookup table (cf. Table I, above). The recommendations may include special offers, discounts, deals, and coupons for selected CPGs from promotion technology engine 140. In some embodiments, advertisement technology server 110 provides a certain list of CPGs and associated target values in terms of a specific campaign, such as price values, timeline of an offer, beginning date, ending date, and market segmentation in terms of the specific characteristic of a target user for the campaign. Accordingly, in some embodiments, advertising and marketing technology server 110 is connected to the digital coupon and promotion technology engine 140 and may be configured to provide recommendations and keywords to creative rendering engine 130. Creative rendering engine 130 generates the advertisement payload according to the parameters, keywords, and recommendations provided by advertisement technology server 110 and promotion technology engine 140, provided as input to an AI or ML algorithm. This may include processing certain logic steps including neural networking algorithms and other techniques, executed by a processor in promotion technology engine 140, in advertisement technology server 110, and in creative rendering engine 130.

System 100 may also include supply side platform (SSP) 120 for a mobile publisher website. In some embodiments, SSP 120 sends a bid request to advertisement technology server 110. Accordingly, advertisement technology server 110 may reply with a bid response including the advertisement payload provided by the brand manufacturer.

SSP 120 may conduct an auction for bids received from one or more vendors (e.g., different advertisement technology servers 110), and select the bid response from a specific advertisement technology server 110. Further, SSP 120 may deliver the advertisement payload to publisher website 105 with mobile device 101. In some embodiments, the payload may include a script (e.g., a javascript, “.js” code) to render the dynamic creative ad-unit including multiple coupons having barcodes, quad codes, and the like.

A browser in mobile device 101 may call dynamic creative rendering engine 130 to create an advertisement payload. Dynamic creative rendering engine 130 may be configured to identify the incoming HTTP application programming interface (API) calling from publisher's website 105 or an application in mobile device 101, containing an identifier for mobile device 101. Dynamic creative rendering engine 130 may then execute commands in an API to provide mobile device 101 a personalized advertisement payload for the consumer.

Advertisement technology server 110 connected to the digital coupon and promotion technology engine 140 may be configured to execute logic commands that use the identifier of mobile device 101 and cross-walk an ID mapping table (e.g., TABLE I, above) to look up the corresponding retailer's FSC-ID (frequent shopper card ID). In some embodiments, advertisement technology server 110 may be configured to execute internal logic to query the retailer's FSC-ID. Advertisement technology server 110 may be connected to digital coupon and promotion technology engine 140 and return a “.json” playlist response of structured advertisement technology content to dynamic creative rendering engine 130 (e.g., an advertising carousel, and the like), as an input to an AI or ML algorithm to generate an advertisement payload.

The “.json” content may include a playlist of limited advertisement items (e.g., ads, coupons, and the like) that may be used as input to an A or ML algorithm to generate an image or a sequence of images or video to be provided to mobile device 101 as an advertisement payload, embedded in a media stream provided by SSP 120. The advertisement payload is rendered and displayed in mobile device 101 for the user quickly and efficiently (e.g., as the user walks through the aisles in a grocery store, or at the cashier, to apply coupons at the time of payment). In some embodiments including geofencing for in-store notifications, dynamic creative rendering engine 130 pushes advertisement payload when it is determined that the mobile device is within the confines of a retail store subscribed to system 100, wherein GPCs identified with universal product codes (UPCs) handled by advertisement technology server 110 are sold, and when the consumer has previously “clipped” offers or coupons associated with the branded CPG on sale at the retail store. When the user activates or “clicks” on any one of the coupons presented in the advertisement payload, this action is passed on to promotion technology engine 140, which then “clips” the coupon onto a user's retailer FSC-ID 150. The coupon is then ready to be redeemed at the retailer store, by the user, upon authentication of retailer FSC-ID 150.

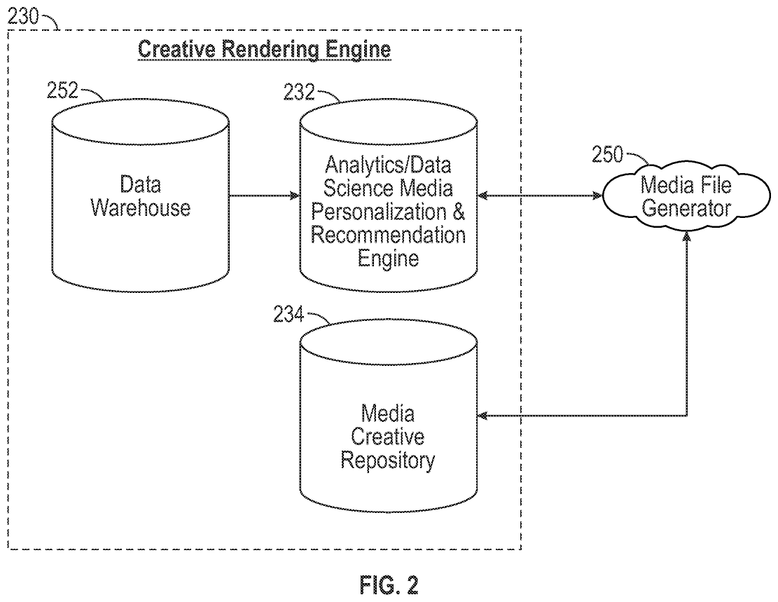

FIG. 2 is a block diagram illustrating a creative rendering engine 230 in more detail. Creative rendering engine 230 may include a data warehouse 252, a personalization and recommendation engine 232, and a media creative repository 234. A media file generator 250 is coupled with creative rendering engine 230, and is configured to generate a media file for an advertisement payload, according to input parameters received from creative rendering engine. Data warehouse 252 may include consumer purchase histories (e.g., associated with an FSC-ID 150). Personalization and recommendation engine 232 provides a selected list of product identifiers for products that are highly likely to be purchased by a given customer, based on a purchasing history retrieved from data warehouse 252. Data personalization and recommendation engine 232 may also have access to a social network and retrieve a consumer public profile from the social network, and even postings from the consumer and other interactions (e.g., ‘likes,’ and the like).

Accordingly, personalization and recommendation engine 232 provides images and branding resources associated with selected products based on a purchasing history of the consumer, to media file generator 250. Media file generator may be a machine learning model or an artificial intelligence model (e.g., an LLM, and the like) provided by a third-party, separate from a retailer, brand manufacturer, or advertising agency.

The type of artificial intelligence software used by media file generator 250 to auto-generate the creative may include a Large Language Model (LLM) such as DALL-E-2, chatGPT, or similar models which may be refined and updated based on continuing purchase experiences with consumers. These LLMs may be offered to the market by third-party organizations.

In some embodiments, a general purpose LLM software generates an advertisement payload and then creative rendering engine 230 performs fine-tuning or training on top of the base LLM. For example, the DALL-E-2 software might be requested to combine the product shots with various text “prompts,” and the most appealing of the combinations would be identified by a human trained in digital creative construction. Such human-curated examples would be fed into the fine-tuning mechanism.

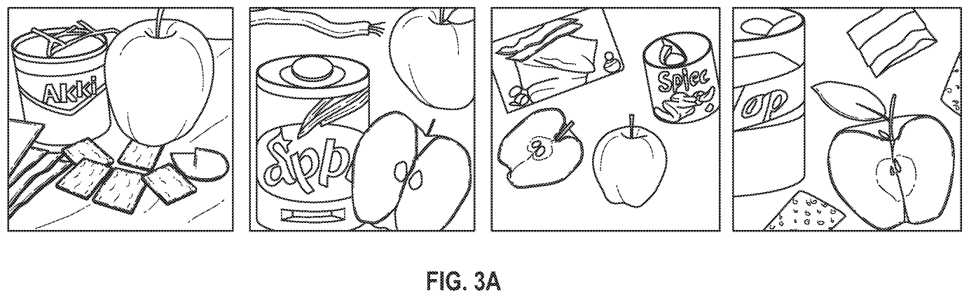

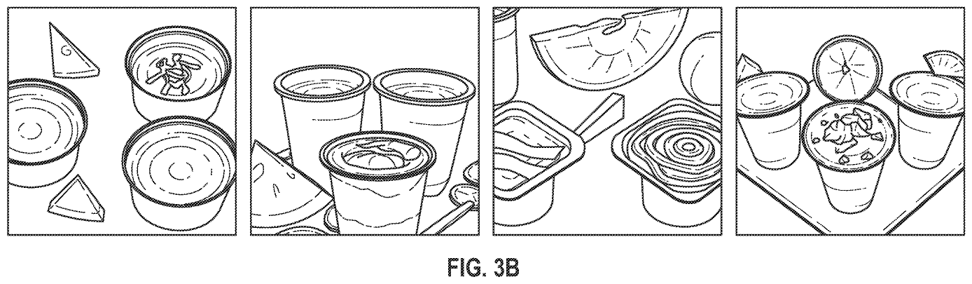

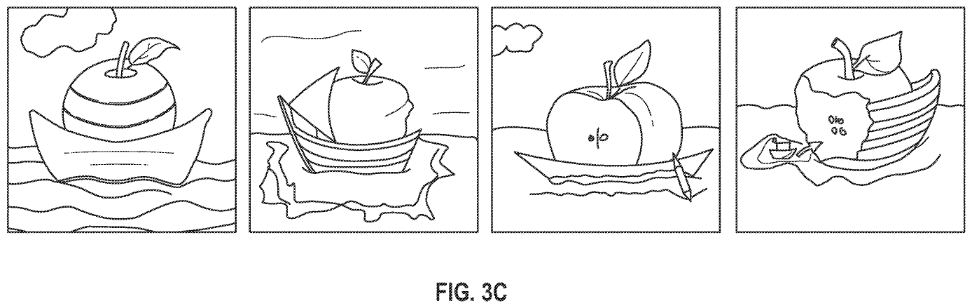

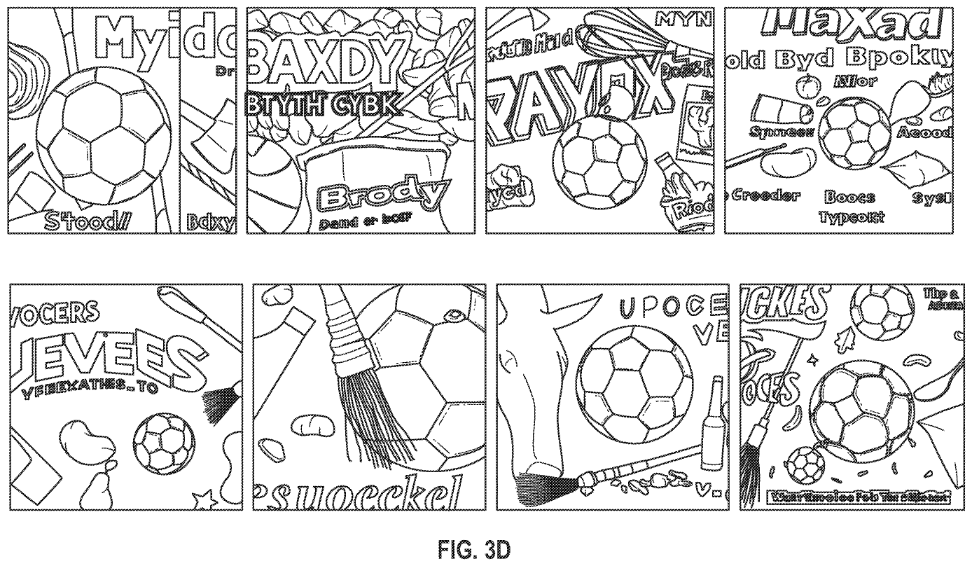

FIGS. 3A-3D illustrate several screenshots of advertisement payloads and media files provided by a media file generator using an ML or AI model in response to different keywords and input queries. One possible scenario resulting in the screenshots is as follows: in a grocery retail setting, there is a set of many different products on sale, possibly hundreds. The goal of the personalization engine (e.g., engine 232) is to recommend to each shopper a small number—say, between 5 and 20—of those promoted products which data science software predicts would have a high likelihood of being purchased by the shopper, in real time. This personalization reduces search costs for the consumer, allowing them to quickly understand what's on sale and what might appeal to them, based on the recommended 5-20 sale items, without having to review the list of hundreds of items on sale. The data science provided by the personalization and recommendation engine is based on past purchase behavior for the household and machine learning algorithms, as disclosed herein.

After the personalization and recommendation engine recommends a small number of products best suited to the consumer, another software based on artificial intelligence (e.g., media file generator 250) auto-generates a creative, which represents or encapsulates the recommended sale products. This process might rely on an input library of product shots provided by the retailer (e.g., data warehouse 252), or might scour the internet for images of the promoted products, along with some standard text messages to be placed on the creative (the advertisement payload), possible links upon which the consumer might click, and potentially other items. The artificial intelligence software combines the images of the recommended products, the standard creative text message, the clickable links, and possibly other items, into a visually appealing final creative. This creative is then served to consumers through various digital channels such as mobile-web, mobile in-app, desktop, connected TV, and other possible distribution mechanisms, via standard digital marketing methods.

FIG. 3A illustrates exemplary media files provided when the input query is “create an image including an apple and a can of soup and beef jerky and salty snacks.”

FIG. 3B illustrates exemplary media files provided when the input query is “create an image of a yogurt, a watermelon, and orange juice.”

FIG. 3C illustrates exemplary media files provided when the input query is “draw me an image of an apple sailing in a boat in the middle of the ocean.”

FIG. 3D illustrates exemplary media files provided when the input query is “create an advertisement with the caption: ‘My Brand rocks,’ including an apple, beef jerky, salty snacks, a broom, and a soccer ball.”

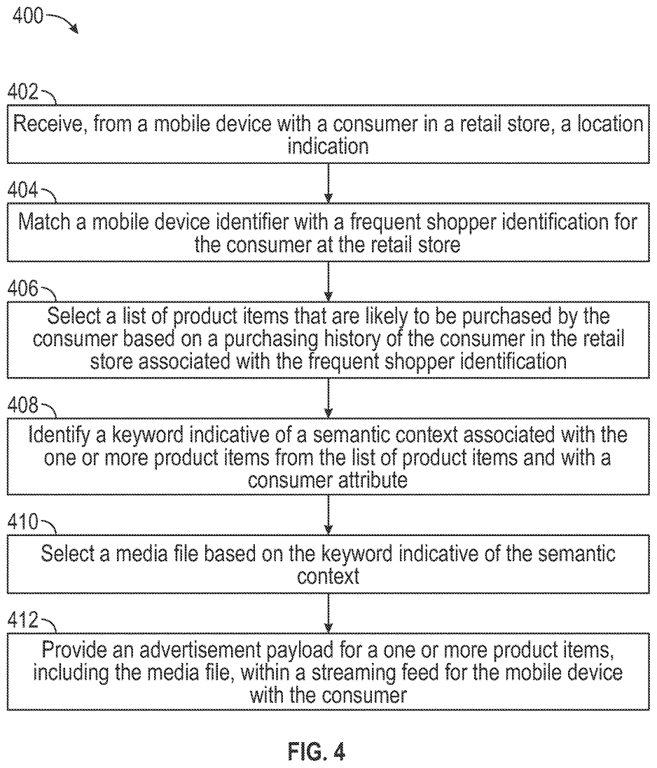

FIG. 4 illustrates steps in a method 400 for providing a personalized advertisement payload to a consumer, according to some embodiments. Method 400 may be performed at least partially by any one of the plurality of servers illustrated in FIG. 1. For example, at least some of the steps in method 400 may be performed by one component in a system including a mobile device running code for a browser and an application to access the publisher website, and an advertisement technology system connected to the digital coupon and promotion technology engine that processes logic to a select advertisement playlist for a dynamic creative rendering server to push the advertisement payload to the mobile device, the system also including a publisher SSP that requests advertisement bids from, and is registered with, an advertisement technology engine (e.g., system 100, mobile device 101, publisher website 105, advertisement technology server 110, publisher SSP 120, dynamic creative rendering engine 130, and promotion technology engine 140). Accordingly, at least some of the steps in method 400 may be performed by a processor executing commands stored in a memory of the server or the mobile device, or accessible by the server or the mobile device. Further, in some embodiments, at least some of the steps in method 400 may be performed overlapping in time, almost simultaneously, or in a different order from the order illustrated in method 400. Moreover, a method consistent with some embodiments disclosed herein may include at least one, but not all, of the steps in method 400.

Step 402 includes receiving, from a mobile device with a consumer in a retail store, a location indication.

Step 404 includes matching a mobile device identifier with a frequent shopper identification for the consumer at the retail store.

Step 406 includes selecting a list of product items that are likely to be purchased by the consumer based on a purchasing history of the consumer in the retail store associated with the frequent shopper identification. In some embodiments, step 406 includes ranking the list of product items based on a likelihood of purchase by the consumer, a price, and an availability of the one or more product items at the retail store. In some embodiments, step 406 includes matching the purchasing history of the consumer with a list of items in an advertising campaign by the retail store.

Step 408 includes identifying a keyword indicative of a semantic context associated with one or more product items from the list of product items and with a consumer attribute. For example, a keyword for an item can be identified from metadata associated with an image. In one aspect, a Universal Product Code (UPC) text description of one or more of the product items in an advertisement can be used as a keyword. In another aspect, the keyword can be identified from descriptors such as brand description, product category and other identifiers associated with a product item. In these cases, the metatags and product descriptors associated with a media file of a product can be used to generate a grouping of words for a keyword identification. In some embodiments, step 408 includes identifying the consumer attribute from a posting of the consumer in a social network portal. In some embodiments, step 408 includes retrieving one or more postings of the consumer in a social network to identify the consumer attribute. In some embodiments, step 408 includes identifying the consumer attribute based on the purchasing history of the consumer. In other aspects, the consumer attribute can comprise the recency, frequency, tenure, consistency, and/or total expenditure on the promoted product or related products.

Step 410 includes selecting a media file based on the keyword indicative of the semantic context. In some embodiments, step 410 includes providing the keyword to a third-party machine learning service, and receiving the media file generated by the third-party machine learning service. In some embodiments, step 410 includes using the keyword as input for a machine learning algorithm, further including updating the machine learning algorithm when the consumer purchases at least one of the one or more product items. In some embodiments, step 410 includes using the keyword as input for a machine learning algorithm, further including updating the machine learning algorithm when the consumer has not purchased at least one of the one or more product items after a pre-selected period of time. In some embodiments, step 410 includes selecting a media file including a human model with the consumer attribute.

In a further aspect, the machine learning algorithm and/or other program instructions can be configured to instruct the processor to determine a spatial arrangement of the advertisement payload on the GUI of the client device. In yet a further aspect, results of the machine learning algorithm can automatically update the icon spatial arrangement and/or size of the icons and/or visual elements of the advertisement payload based on spacing limitations of the GUI interactive surface on the respective user device; memory limitations of the user device; and/or additional user preference data associated with product item. For example, multiple advertisement images (e.g., BUBBA BURGER® Veggie Burgers, DASANI® water, KRAFT® macaroni & cheese) can be recommended via the machine learning algorithm, and a summary image (screenshot) as depicted in FIGS. 3A-3D containing the advertisement images would be generated. Further, the size and arrangements of the advertisement images can have their respective spatial orientation in the display and/or GUI changed based on the program instructions and/or result of the machine learning model. In another aspect, a ranking or score associated with a preferred product item provided in the advertisement payload can determine the location and/or size of the advertisement in the display and/or GUI of the user device.

Step 412 includes providing an advertisement payload for a one or more product items, including the media file, within a streaming feed for the mobile device with the consumer. In some embodiments, step 412 includes providing a coupon, an offer, or a value-added certificate for at least one of the one or more product items based on a reward score for the frequent shopper identification. In some embodiments, step 412 includes providing a garment advertisement for the consumer, and the media file includes an image of a human model having the consumer attribute wearing a garment for purchase.

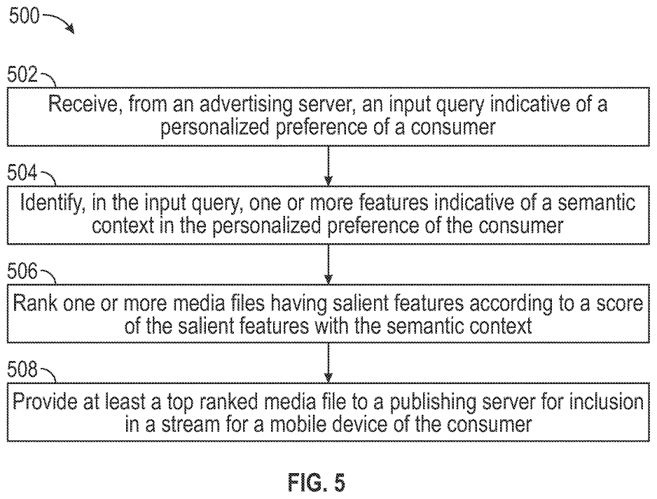

FIG. 5 illustrates steps in a method 500 for generating a personalized advertisement payload to a consumer, according to some embodiments. The ads are generated by a creative rendering engine running AI and ML algorithms. The inputs to the AI and ML algorithms in the creative rendering engine are provided by an advertisement technology system connected to a digital coupon and promotion technology engine, according to some embodiments. Method 500 may be performed at least partially by any one of the plurality of devices, servers, and engines illustrated in FIG. 1. For example, at least some of the steps in method 500 may be performed by one component in a system including a mobile device running code for a browser and an application to access a publisher website hosted by a publisher SSP (e.g., system 100, mobile device 101, publisher website 105, advertisement technology server 110, publisher SSP 120, creative rendering engine 130, and promotion technology engine 140). Accordingly, at least some of the steps in method 500 may be performed by a processor executing commands stored in a memory of the server, or accessible by the server. Further, in some embodiments, at least some of the steps in method 500 may be performed overlapping in time, almost simultaneously, or in a different order than the order illustrated in method 500. Moreover, a method consistent with some embodiments disclosed herein may include at least one, but not all, of the steps in method 500.

Step 502 includes receiving, from an advertising server, an input query indicative of a personalized preference of a consumer.

Step 504 includes identifying, in the input query, one or more features indicative of a semantic context in the personalized preference of the consumer.

Step 506 includes ranking one or more media files having salient features according to a score of the salient features with the semantic context. For example, a semantic context can comprise shopper personality, wherein categories of the shopper personality can include an ingredient-based personality (e.g., Gluten Avoider), and lifestyle personality (e.g., Fitness Fanatic). The salient features can comprise characteristics associated a media image. Within the machine learning algorithm a product item can be scored and ranked based on how the product item is associated with the respective salient feature. The salient features for an exercise bike can comprise physical or purpose descriptors of the product item in the image (e.g. exercise equipment, cardio-vascular training, resistance training, and the like) Further, a product item and associated media file can have a different ranking relative to the salient feature (e.g. an exercise bike can have a higher score with respect to a lifestyle personality than an ingredient based personality. In some embodiments, step 506 includes identifying the salient features of the one or more media files, assigning a numeric value to each of the salient features to form a vector in a multidimensional space, defining the semantic context as a first axis in the multidimensional space, and evaluating a projection of the vector on the first axis. In some embodiments, step 506 includes generating at least one image having a salient feature including a score with the semantic context higher than a pre-selected value. In some embodiments, step 506 includes generating at least one media file including an image of a consumer product that has the salient features.

Step 508 includes providing at least a top ranked media file to a publishing server for inclusion in a stream for a mobile device of the consumer. In some embodiments, step 508 further includes updating a scoring engine that provides the score of the salient features with the semantic context when the consumer has not purchased a product item associated with one of the media files after a pre-selected period of time.

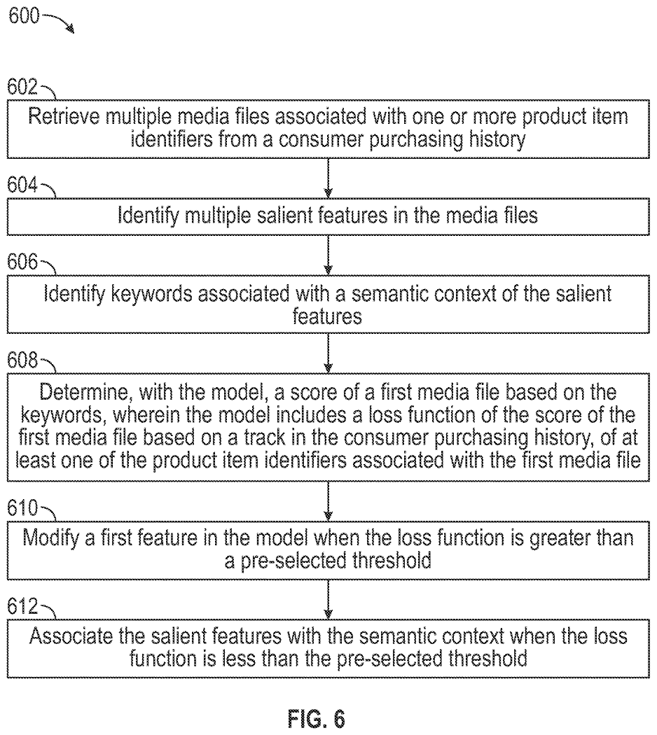

FIG. 6 illustrates steps in a method 600 for training a model to generate a personalized advertisement payload for a consumer, according to some embodiments. The ads are generated by a creative rendering engine running AI and ML algorithms. The inputs to the AI and ML algorithms in the creative rendering engine are provided by an advertisement technology system connected to a digital coupon and promotion technology engine, according to some embodiments. Method 600 may be performed at least partially by any one of the plurality of devices, servers, and engines illustrated in FIG. 1. For example, at least some of the steps in method 600 may be performed by one component in a system including a mobile device running code for a browser and an application to access a publisher website hosted by a publisher SSP (e.g., system 100, mobile device 101, publisher website 105, advertisement technology server 110, publisher SSP 120, creative rendering engine 130, and promotion technology engine 140). Accordingly, at least some of the steps in method 600 may be performed by a processor executing commands stored in a memory of the server, or accessible by the server. Further, in some embodiments, at least some of the steps in method 500 may be performed overlapping in time, almost simultaneously, or in a different order than the order illustrated in method 600. Moreover, a method consistent with some embodiments disclosed herein may include at least one, but not all, of the steps in method 600.

Step 602 includes retrieving multiple media files associated with one or more product item identifiers from a consumer purchasing history. In some embodiments, step 602 includes retrieving a media file including a human model having a consumer attribute. In some embodiments, step 602 includes generating a media file based on at least one of the salient features in the media files.

Step 604 includes identifying multiple salient features in the media files.

Step 606 includes identifying keywords associated with a semantic context of the salient features.

Step 608 includes determining, with the model, a score of a first media file based on the keywords, wherein the model includes a loss function of the score of the first media file based on a track, in the consumer purchasing history, of at least one of the product item identifiers associated with the first media file. In some embodiments, step 608 includes assigning a numeric value to each of the salient features to form a vector in a multidimensional space, defining the semantic context as a first axis in the multidimensional space, and evaluating a projection of the vector on the first axis.

Step 610 includes modifying a first feature in the model when the loss function is greater than a pre-selected threshold.

Step 612 includes associating the salient features with the semantic context when the loss function is less than the pre-selected threshold. In some embodiments, step 612 further includes receiving a keyword indicative of a semantic context associated with a second consumer located at a retail store, generating, with the model, a media file based on the semantic context, and providing an advertisement payload including the media file in a streaming feed for a mobile device with the consumer. In some embodiments, step 612 further includes updating the model when a consumer that received an advertisement payload including a media file generated by the model has not purchased a product associated with the advertisement payload after a selected period of time.

The subject technology is illustrated, for example, according to various aspects described below. Various examples of aspects of the subject technology are described as numbered clauses (clause 1, 2, etc.) for convenience. These are provided as examples, and do not limit the subject technology.

Clause 1: A computer-implemented method that includes: receiving, from a mobile device with a consumer in a retail store, a location indication, matching a mobile device identifier with a frequent shopper identification for the consumer at the retail store, selecting a list of product items that are likely to be purchased by the consumer based on a purchasing history of the consumer in the retail store associated with the frequent shopper identification, identifying a keyword indicative of a semantic context associated with one or more product items from the list of product items and with a consumer attribute, selecting a media file based on the keyword indicative of the semantic context, and providing an advertisement payload for a one or more product items, including the media file, within a streaming feed for the mobile device with the consumer.

Clause 2: A computer-implemented method that includes: receiving, from an advertising server, an input query indicative of a personalized preference of a consumer, identifying, in the input query, one or more features indicative of a semantic context in the personalized preference of the consumer, ranking one or more media files having salient features according to a score of the salient features with the semantic context, and providing at least a top ranked media file to a publishing server for inclusion in a stream for a mobile device of the consumer.

Clause 3: A computer-implemented method for training a model to generate an advertisement payload for a consumer that includes: retrieving multiple media files associated with one or more product item identifiers from a consumer purchasing history, identifying multiple salient features in the media files, identifying keywords associated with a semantic context of the salient features, determining, with the model, a score of a first media file based on the keywords, wherein the model includes a loss function of the score of the first media file based on a track, in the consumer purchasing history, of at least one of the product item identifiers associated with the first media file, modifying a first feature in the model when the loss function is greater than a pre-selected threshold, and associating the salient features with the semantic context when the loss function is less than the pre-selected threshold.

The clauses may be combined with any of the following elements in any order, number, and permutation, as follows.

Element 1, wherein selecting a list of product items includes ranking the list of product items based on a likelihood of purchase by the consumer, a price, and an availability of the one or more product items at the retail store. Element 2, wherein selecting a list of product items includes matching the purchasing history of the consumer with a list of items in an advertising campaign by the retail store. Element 3, wherein identifying the keyword indicative of a semantic context includes identifying the consumer attribute from a posting of the consumer in a social network portal. Element 4, wherein selecting a media file includes receiving, from an advertising technology server, an image including one or more product items. Element 5, wherein selecting a list of product items includes correlating the purchase history of the consumer with a list of products in an advertisement campaign promoted at the retail store. Element 6, wherein selecting a media file based on the keyword includes providing the keyword to a third-party machine learning service, and receiving the media file generated by the third-party machine learning service. Element 7, wherein selecting a media file based on the keyword includes using the keyword as input for a machine learning algorithm, further including updating the machine learning algorithm when the consumer purchases at least one of the one or more product items. Element 8, wherein selecting a media file based on the keyword includes using the keyword as input for a machine learning algorithm, further including updating the machine learning algorithm when the consumer has not purchased at least one of the one or more product items after a pre-selected period of time. Element 9, wherein providing an advertisement payload for one or more product items includes providing a coupon, an offer, or a value-added certificate for at least one of the one or more product items based on a reward score for the frequent shopper identification. Element 10, wherein identifying a keyword indicative of a semantic context associated with the one or more product items includes retrieving one or more postings of the consumer in a social network to identify the consumer attribute. Element 11, wherein identifying a keyword indicative of a semantic context includes identifying the consumer attribute based on the purchasing history of the consumer. Element 12, wherein selecting a media file includes selecting a media file including a human model with the consumer attribute. Element 13, wherein providing an advertisement payload includes providing a garment advertisement for the consumer, and the media file includes an image of a human model having the consumer attribute wearing a garment for purchase.

Element 14, wherein ranking one or more media files includes retrieving the media files from a database based on the score of the salient features with the semantic context. Element 15, wherein ranking one or more media files includes identifying the salient features of the one or more media files, assigning a numeric value to each of the salient features to form a vector in a multidimensional space, defining the semantic context as a first axis in the multidimensional space, and evaluating a projection of the vector on the first axis. Element 16, wherein ranking one or more images includes generating at least one image having a salient feature including a score with the semantic context higher than a pre-selected value. Element 17, wherein ranking one or more media files includes generating at least one media file including an image of a consumer product that has the salient features. Element 18, further including updating a scoring engine that provides the score of the salient features with the semantic context when the consumer has not purchased a product item associated with one of the media files after a pre-selected period of time.

Element 19, wherein determining a score of the first media file based on the keywords includes assigning a numeric value to each of the salient features to form a vector in a multidimensional space, defining the semantic context as a first axis in the multidimensional space, and evaluating a projection of the vector on the first axis. Element 20, further including: receiving a keyword indicative of a semantic context associated with a second consumer located at a retail store, generating, with the model, a media file based on the semantic context, and providing an advertisement payload including the media file in a streaming feed for a mobile device with the consumer. Element 21, further including updating the model when a consumer that received an advertisement payload including a media file generated by the model has not purchased a product associated with the advertisement payload after a selected period of time. Element 22, wherein retrieving multiple media files associated with one or more product item identifiers includes retrieving a media file including a human model having a consumer attribute. Element 23, wherein retrieving multiple media files associated with one or more product item identifiers includes generating a media file based on at least one of the salient features in the media files.

In one aspect, a method may be an operation, an instruction, or a function and vice versa. In one aspect, a clause may be amended to include some or all of the words (e.g., instructions, operations, functions, or components) recited in other one or more clauses, one or more words, one or more sentences, one or more phrases, one or more paragraphs, and/or one or more clauses.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

The clauses are not intended to be limited to the aspects described herein, but are to be accorded the full scope consistent with the language clauses and to encompass all legal equivalents. Notwithstanding, none of the clauses are intended to embrace subject matter that fails to satisfy the requirements of the applicable patent law, nor should they be interpreted in such a way.

What is claimed is:

1. A computer-implemented method for generating an advertisement payload for a user, the method comprising:
receiving, from a mobile device with a consumer in a retail store, a location indication;
matching a mobile device identifier with a frequent shopper identification for the consumer at the retail store;
selecting a list of product items that are likely to be purchased by the consumer based on a purchasing history of the consumer in the retail store associated with the frequent shopper identification;
identifying a keyword indicative of a semantic context associated with one or more product items from the list of product items and with a consumer attribute;
selecting a media file based on the keyword indicative of the semantic context; and
providing an advertisement payload for a one or more product items, including the media file, within a streaming feed for the mobile device with the consumer.

2. The method of claim 1 wherein selecting a list of product items includes ranking the list of product items based on a likelihood of purchase by the consumer, a price, and an availability of the one or more product items at the retail store.

3. The method of claim 1, wherein selecting a list of product items includes matching the purchasing history of the consumer with a list of items in an advertising campaign by the retail store.

4. The method of claim 1, wherein identifying the keyword indicative of a semantic context includes identifying the consumer attribute from a posting of the consumer in a social network portal.

5. The method of claim 1, wherein selecting a media file includes receiving, from an advertising technology server, an image including one or more product items.

6. The method of claim 1, wherein selecting a list of product items includes correlating the purchase history of the consumer with a list of products in an advertisement campaign promoted at the retail store.

7. The method of claim 1, wherein selecting a media file based on the keyword includes providing the keyword to a third-party machine learning service, and receiving the media file generated by the third-party machine learning service.

8. The method of claim 1, wherein selecting a media file based on the keyword includes using the keyword as input for a machine learning algorithm.

9. The method of claim 8, further comprising updating the machine learning algorithm in response to the consumer purchase of at least one of the one or more product items.

10. The method of claim 8, further comprising updating the machine learning algorithm after expiration of a pre-selected period of time and a determination of a purchase of the one or more product items.

11. The method of claim 1, further comprising providing a coupon, an offer, or a value-added certificate for at least one of the one or more product items based on a reward score for the frequent shopper identification.

12. The method of claim 1 wherein identifying a keyword indicative of a semantic context includes identifying the consumer attribute based on the purchasing history of the consumer.

13. The method of claim 1 further comprising ranking one or more media files associated with the one or more product items.

14. The method of claim 13, wherein ranking the one or more media files comprises retrieving the one or more media files from a database based on a score of a salient feature with the semantic context.

15. The method of claim 13, wherein ranking one or more images includes generating at least one image having a salient feature including a score with the semantic context higher than a pre-selected value.

16. The method of claim 15 wherein ranking one or more media files includes:
identifying a salient feature of the one or more media files,
assigning a numeric value to each of the salient feature to form a vector in a multidimensional space,
defining the semantic context as a first axis in the multidimensional space, and
evaluating a projection of the vector on the first axis.

17. The method of claim 13, wherein ranking one or more media files includes generating at least one media file including an image of a consumer product that has the salient feature.

18. A system, comprising:
a memory storing multiple instructions;
one or more processors configured to execute the instructions to cause the system to:
receive, from a mobile device with a consumer in a retail store, a location indication;
match a mobile device identifier with a frequent shopper identification for the consumer at the retail store;
select a list of product items that are likely to be purchased by the consumer based on a purchasing history of the consumer in the retail store associated with the frequent shopper identification;
identify a keyword indicative of a semantic context associated with one or more product items from the list of product items and with a consumer attribute;
select a media file based on the keyword indicative of the semantic context; and
provide an advertisement payload for a one or more product items, including the media file, within a streaming feed for the mobile device with the consumer.

19. The system of claim 18, wherein the one or more processors being configured to execute the instructions to cause the system to select a list of product items includes matching the purchasing history of the consumer with a list of items in an advertising campaign by the retail store.

20. The system of claim 18, wherein the one or more processors being configured to execute the instructions to cause the system to identify the keyword indicative of a semantic context includes identifying the consumer attribute from a posting of the consumer in a social network portal.

21. The system of claim 18, wherein the one or more processors being configured to execute the instructions to cause the system to select a media file based on the keyword includes providing the keyword to a third-party machine learning service, and receiving the media file generated by the third-party machine learning service.

22. The system of claim 18, wherein the one or more processors being configured to execute the instructions to cause the system to select a media file based on the keyword includes using the keyword as input for a machine learning algorithm.

23. The system of claim 22, wherein the instructions are further configured to cause the system to update the machine learning algorithm in response to the consumer purchase of at least one of the one or more product items.

24. The system of claim 22, wherein the instructions are further configured to cause the system to update the machine learning algorithm after expiration of a pre-selected period of time and a determination of a purchase of the one or more product items.

25. The system of claim 18, wherein the instructions are further configured to cause the system to rank one or more media files associated with the one or more product items.

26. The system of claim 25, wherein the one or more processors being configured to execute the instructions to cause the system to rank the one or more media files comprises retrieving the one or more media files from a database based on a score of a salient feature with the semantic context.

27. The system of claim 25, wherein the one or more processors being configured to execute the instructions to cause the system to rank the one or more images includes generating at least one image having a salient feature including a score with the semantic context higher than a pre-selected value.

28. The system of claim 25 wherein the one or more processors being configured to execute the instructions to cause the system to rank one or more media files includes:
identifying a salient feature of the one or more media files,
assigning a numeric value to each of the salient feature to form a vector in a multidimensional space,
defining the semantic context as a first axis in the multidimensional space, and
evaluating a projection of the vector on the first axis, and
generating at least one media file including an image of a consumer product that has the salient feature.

29. A non-transitory computer-readable medium storing instructions which, when executed by a processor, cause a computer to perform a method for generating an advertisement payload for a user, the method comprising:
receiving, from a mobile device with a consumer in a retail store, a location indication;
matching a mobile device identifier with a frequent shopper identification for the consumer at the retail store;
selecting a list of product items that are likely to be purchased by the consumer based on a purchasing history of the consumer in the retail store associated with the frequent shopper identification;
identifying a keyword indicative of a semantic context associated with one or more product items from the list of product items and with a consumer attribute;
selecting a media file based on the keyword indicative of the semantic context; and
providing an advertisement payload for a one or more product items, including the media file, within a streaming feed for the mobile device with the consumer.

30. The non-transitory computer-readable medium of claim 29, wherein selecting a list of product items includes matching the purchasing history of the consumer with a list of items in an advertising campaign by the retail store.

31. The non-transitory computer-readable medium of claim 29, wherein identifying the keyword indicative of a semantic context includes identifying the consumer attribute from a posting of the consumer in a social network portal.

32. The non-transitory computer-readable medium of claim 29, wherein selecting a media file includes receiving, from an advertising technology server, an image including one or more product items.

33. The non-transitory computer-readable medium of claim 29, wherein selecting a list of product items includes correlating the purchase history of the consumer with a list of products in an advertisement campaign promoted at the retail store.

34. The non-transitory computer-readable medium of claim 29, wherein selecting a media file based on the keyword includes providing the keyword to a third-party machine learning service, and receiving the media file generated by the third-party machine learning service.

35. The non-transitory computer-readable medium of claim 29, wherein selecting a media file based on the keyword includes using the keyword as input for a machine learning algorithm.

36. The non-transitory computer-readable medium of claim 35, further comprising updating the machine learning algorithm in response to the consumer purchase of at least one of the one or more product items.

37. The non-transitory computer-readable medium of claim 35, further comprising updating the machine learning algorithm after expiration of a pre-selected period of time and a determination of a purchase of the one or more product items.

38. The non-transitory computer-readable medium of claim 29, further comprising providing a coupon, an offer, or a value-added certificate for at least one of the one or more product items based on a reward score for the frequent shopper identification.

39. The non-transitory computer-readable medium of claim 29 wherein identifying a keyword indicative of a semantic context includes identifying the consumer attribute based on the purchasing history of the consumer.

40. The non-transitory, computer-readable medium of claim 29 further comprising ranking one or more media files associated with the one or more product items.

41. The non-transitory computer-readable medium of claim 40, wherein ranking the one or more media files comprises retrieving the one or more media files from a database based on a score of a salient feature with the semantic context.

42. The non-transitory computer-readable medium of claim 40, wherein ranking one or more images includes generating at least one image having a salient feature including a score with the semantic context higher than a pre-selected value.

43. The non-transitory computer-readable medium of claim 40 wherein ranking one or more media files includes:
identifying a salient feature of the one or more media files,
assigning a numeric value to each of the salient feature to form a vector in a multidimensional space,
defining the semantic context as a first axis in the multidimensional space, and
evaluating a projection of the vector on the first axis.

44. The non-transitory computer-readable medium of claim 40, wherein ranking one or more media files includes generating at least one media file including an image of a consumer product that has the salient feature.
